(19) United States
(12) Patent Application Publication
(10) Pub. No.: US 2009/0281717 A1
(43) Pub. Date: Nov. 12, 2009

(54) INFORMATION PROVIDING DEVICE, INFORMATION PROVIDING METHOD, AND INFORMATION PROVIDING PROGRAM

(75) Inventor: Ippei Nambata, Kawagoe-Shi (JP)

Correspondence Address: YOUNG & THOMPSON, 209 Madison Street, Suite 500, ALEXANDRIA, VA, 22314, US

(73) Assignee: Pioneer Corporation, Tokyo (JP)

(21) Appl. No.: 12/302,842

(22) PCT Filed: May 28, 2007
(86) PCT No.: PCT/JP2007/060814

§ 371 Date: Feb. 2, 2009

(30) Foreign Application Priority Data
Jun. 2, 2006 (JP) 2006-154495

(51) Int. Cl. G01C 21/36; G09B 29/10

(52) U.S. Cl. 701/200; 434/153

(57) ABSTRACT

There is provided an information supplying apparatus and an information supplying method capable of obtaining an aptitude for a route to a destination for each driver. The information supplying apparatus is used for obtaining the aptitude for the route to the destination for each user. The road information storage unit stores the road information. The route calculation unit calculates the route from the departure place to the destination, based on the road information. The driving characteristic information storage unit stores the driving characteristic information showing the experience value and the ability for driving for each of the plural users. The aptitude calculation unit calculates the aptitude for the route for each user, based on the characteristic information. The display control unit displays the image corresponding to the aptitude calculated by the aptitude calculation unit. Thereby, in such a case that the plural users own the single vehicle in common, it becomes possible to appropriately determine the driver suitable for the route to the destination.

### TECHNICAL FIELD

The present invention relates to a technique of obtaining an aptitude for a route to a destination based on driving characteristic information about driving for each of plural users.

### BACKGROUND TECHNIQUE

Conventionally, there is known a navigation apparatus which is mounted on a vehicle and which calculates an optimum route from a departure place to a destination. For example, there is disclosed an optimum route searching apparatus which displays a traveling time, a distance, a cost and a fatigue degree of each route at a time of displaying plural route candidates in Patent Reference-1.

However, by the technique according to Patent Reference-1, it is impossible to obtain the aptitude for the searched route for each driver in consideration of an experience of a driver.

Patent Reference-1: Japanese Patent Application Laid-open under No. H10-26932

### DISCLOSURE OF INVENTION

### Problem to be Solved by the Invention

The present invention has been achieved in order to solve the above problem. It is an object of this invention to provide an information supplying apparatus and an information supplying method capable of obtaining an aptitude for a route to a destination for each driver.

According to one aspect of the present invention, there is provided an information supplying apparatus including: a road information storage unit which stores road information; a route calculation unit which calculates a route from a departure place to a destination based on the road information; a driving characteristic information storage unit which stores driving characteristic information about driving for each of plural users; an aptitude calculation unit which calculates an aptitude for the route calculated by the route calculation unit for each user, based on the driving characteristic information; and a display control unit which displays an image corresponding to the aptitude calculated by the aptitude calculation unit.

The above information supplying apparatus is used for obtaining the aptitude for the route to the destination for each user. The road information storage unit stores the road information. The route calculation unit calculates the route from the departure place to the destination based on the road information. The driving characteristic information storage unit stores the driving characteristic information showing experience value and ability of driving for each of the plural users. The aptitude calculation unit calculates the aptitude for the route for each user, based on the characteristic information. The display control unit displays the image corresponding to the aptitude calculated by the aptitude calculation unit. Thereby, in such a case that the plural users own the single vehicle, it becomes possible to appropriately determine the driver suitable for the route to the destination.

In a manner of the above information supplying apparatus, the display control unit may display the aptitude calculated for each user as a list. Thereby, it becomes possible to recognize the aptitudes of all the users.

In another manner of the above information supplying apparatus, the display control unit may display information of a user having a best aptitude by priority, based on the aptitude calculated for each user. Thereby, it becomes possible to immediately recognize the user having the best aptitude.

Preferably, the above information supplying apparatus may further include a weather forecast information obtaining unit which obtains weather forecast information corresponding to the route, wherein the driving characteristic information storage unit stores an aptitude for a weather for each user as the driving characteristic information, and wherein the aptitude calculation unit calculates an aptitude for the route based on the weather forecast information and the aptitude for the weather. Thereby, it becomes possible to choose the user suitable for the weather of the route to the destination.

In a preferred example of the above information supplying apparatus, the driving characteristic information storage unit may store an aptitude for a road type for each user as the driving characteristic information, and the aptitude calculation unit may calculate the aptitude for the route based on the aptitude for the road type. Thereby, it becomes possible to choose the user suitable for the road type in the route to the destination.

In another preferred example of the above information supplying apparatus, the driving characteristic information storage unit may store safe driving ability for each user as the driving characteristic information, and the aptitude calculation unit may calculate the aptitude for the route based on the safe driving ability. Thereby, it becomes possible to choose the user based on the safe driving ability of the user.

In still another preferred example of the above information supplying apparatus, the driving characteristic information storage unit may store a continuous driving ability showing ability capable of continuously driving for each user as the driving characteristic information, and the aptitude calculation unit may calculate the aptitude for the route based on the continuous driving ability. Thereby, it becomes possible to appropriately choose the user corresponding to the calculated route distance.

In still another preferred example of the above information supplying apparatus, the driving characteristic information may be formed by plural parameters. The aptitude calculation unit may include a unit which designates a priority of the parameter used at a time of calculating the aptitude, and may calculate the aptitude by using the parameter based on the designated priority. For example, the plural parameters are formed by the aptitude for the weather, the aptitude for the road type, the safe driving ability and the continuous driving ability. The aptitude calculation unit can calculate the aptitude for each user by weighting the component corresponding to the designated priority.

Preferably, the above information supplying apparatus may further include: a driving information collection unit which collects information about driving of the user during driving, and the driving characteristic information may be updated based on collected driving information.

According to another aspect of the present invention, there is provided an information supplying method which produces information to be displayed on an image display unit, including: a road information obtaining process which obtains road information; a route calculation process which calculates a route from a departure place to a destination based on the road information; a driving characteristic information obtaining process which obtains driving characteristic information about driving for each of plural users; an aptitude calculation process which calculates an aptitude for the route calculated in the route calculation process for each user, based on the driving characteristic information; and a display control process which displays an image corresponding to the aptitude calculated in the aptitude calculation process.

According to still another aspect of the present invention, there is provided an information supplying program executed by a computer for producing information to be displayed on an image display unit, making the computer function as: a road information obtaining unit which obtains road information; a route calculation unit which calculates a route from a departure place to a destination based on the road information; a driving characteristic information obtaining unit which obtains driving characteristic information about driving for each of plural users; an aptitude calculation unit which calculates an aptitude for the route calculated by the route calculation unit for each user based on the driving characteristic information; and a display control unit which displays an image corresponding to the aptitude calculated by the aptitude calculation unit.

By the above information supplying method and the above information supplying program, in such a case that the plural users own the single vehicle, it also becomes possible to appropriately determine the driver suitable for the route to the destination.

### BRIEF DESCRIPTION OF THE DRAWINGS

FIG. 1 is a block diagram schematically showing a configuration of a navigation apparatus according to an embodiment;

FIG. 2 shows an example of a node and a link in a road map;

FIG. 3 shows an example of road information;

FIG. 4 shows an example of driving characteristic information;

FIG. 5 shows an image example for displaying an aptitude calculated for each driver as a list;

FIGS. 6A to 6C show image examples for displaying information of a driver having a best aptitude;

FIG. 7 is a flow chart showing a display control process;

FIG. 8 is a flowchart showing another example of the display control process; and

FIG. 9 is a block diagram showing a configuration of an information supplying device according to a modification.

### BRIEF DESCRIPTION OF THE REFERENCE NUMBER

1 Navigation apparatus
10 Stand-alone position measurement device
18 GPS receiver
20 System controller
22 CPU
36 Data storage unit
40 Display unit
44 Display
60 Input device

### DETAILED DESCRIPTION OF THE PREFERRED EMBODIMENTS

Now, a description will be given of a preferred embodiment of the present invention with reference to attached drawings. The explanation which will be given below shows such an example that the present invention is applied to an on-vehicle navigation apparatus.

### [Navigation Apparatus]

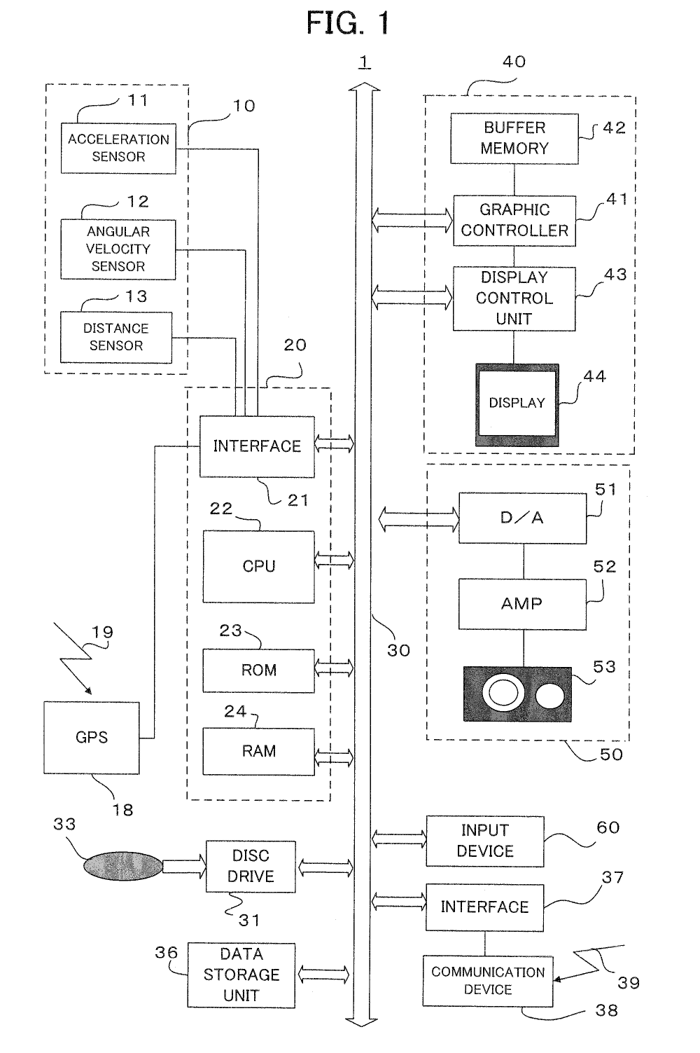

FIG. 1 shows a configuration of a navigation apparatus 1. As shown in FIG. 1, the navigation apparatus 1 includes a stand-alone position measurement device 10, a GPS receiver 18, a system controller 20, a disc drive 31, a data storage unit 36, a communication interface 37, a communication device 38, a display unit 40, a sound output unit 50, and an input device 60.

The stand-alone position measurement device 10 includes an acceleration sensor 11, an angular velocity sensor 12 and a distance sensor 13. The acceleration sensor 11 includes a piezoelectric element, for example, and detects the acceleration degree of the vehicle and outputs the acceleration data. The angular velocity sensor 12 includes a vibration gyroscope, for example, and detects the angular velocity of the vehicle at the time of changing the direction of the vehicle and outputs the angular velocity data and the relative direction data. The distance sensor 13 measures vehicle speed pulses including a pulse signal generated with the wheel rotation of the vehicle.

The GPS receiver 18 receives an electric wave 19 for transmitting downlink data including position measurement data from plural GPS satellites. The position measurement data is used for detecting the absolute position of the vehicle from longitude and latitude information.

The system controller 20 includes an interface 21, a CPU (Center Processing Unit) 22, a ROM (Read Only Memory) 23 and a RAM (Random Access Memory) 24, and controls the entire navigation apparatus 1.

The interface 21 executes the interface operation with the acceleration sensor 11, the angular velocity sensor 12, the distance sensor 13 and the GPS receiver 18. Then, the interface 21 inputs the vehicle speed pulse, the acceleration data, the relative direction data, the angular velocity data, the GPS measurement data and the absolute direction data into the system controller 20. The CPU 22 controls the entire system controller 20. The ROM 23 includes a non-volatile memory (not shown) in which a control program for controlling the system controller 20 is stored. The RAM 24 readably stores various kinds of data such as route data preset by the user via the input device 60, and supplies a working area to the CPU 22.

The system controller 20, the disc drive 31 such as a CD-ROM drive or a DVD-ROM drive, the data storage unit 36, the communication interface 37, the display unit 40, the sound output unit 50 and the input device 60 are connected to each other via a bus line 30.

Under the control of the system controller 20, the disc drive 31 reads contents data such as sound data and video data from a disc 33 such as a CD and a DVD to output the contents data. The disc drive 31 may be the CD-ROM drive or the DVD-ROM drive, or may be a drive compatible between the CD and the DVD.

The data storage unit 36 includes HDD, for example, and stores various kinds of data used for a navigation process such as map data and facility data. In addition, the data storage unit 36 stores the road information about the road and the characteristic information about driving (hereinafter referred to as “driving characteristic information”) for each user (driver). In this manner, the data storage unit 36 functions as the road information storage unit and the driving characteristic information storage unit.

The communication device 38 includes an FM tuner, a beacon receiver, a mobile phone and a dedicated communication card, for example, and obtains the information delivered from a VICS (Vehicle Information Communication System) center via the communication interface 37. For example, the communication device 38 obtains weather information at a predetermined position.

The display unit 40 displays various kinds of display data on a display device such as a display under the control of the system controller 20. Concretely, the system controller 20 reads the map data from the data storage unit 36. The display unit 40 displays, on a display screen, the map data read from the data storage unit 36 by the system controller 20. The display unit 40 includes a graphic controller 41 for controlling the entire display unit 40 on the basis of the control data transmitted from the CPU 22 via the bus line 30, a buffer memory 42 having a memory such as a VRAM (Video RAM) for temporarily storing immediately displayable image information, a display control unit 43 for controlling a display 44 such as a liquid crystal and a CRT (Cathode Ray Tube) on the basis of the image data outputted from the graphic controller 41, and the display 44. The display 44, which functions as the image display unit, is formed by a liquid crystal display device of the opposite angle 5-10 inches, and is mounted in the vicinity of a front panel of the vehicle.

The sound output unit 50 includes a D/A converter 51 for executing D/A (Digital to Analog) conversion of the sound digital data transmitted from the CD-ROM drive 31, a DVD-ROM 32 or the RAM 24 via the bus line 30 under the control of the system controller 20, an amplifier (AMP) 52 for amplifying a sound analog signal outputted from the D/A converter 51, and a speaker 53 for converting the amplified sound analog signal into the sound and outputting it to the vehicle compartment.

The input device 60 includes keys, switches, buttons, a remote controller and a sound input device, which are used for inputting various kinds of commands and data. The input device 60 is arranged in the vicinity of the display 44 and a front panel of a main body of an on-vehicle electric system loaded on the vehicle. Additionally, in such a case that the display 44 is in a touch panel system, a touch panel provided on the display screen of the display 44 functions as the input device 60, too.

In the embodiment, the navigation apparatus 1 obtains the departure place and the destination from the driver, and calculates the route to the destination from the departure place (namely, searches the route) with reference to the above map data and road information. The navigation apparatus 1 calculates the aptitude for the calculated route for each driver based on the above driving characteristic information.

The navigation apparatus 1 functions as the information supplying apparatus according to the present invention. Namely, the CPU 22 functions as the route calculation unit and the aptitude calculation unit. In addition, the CPU 22 and the display control unit 43 function as the display control unit.

### [Road Information]

Next, a description will be given of the road information. The road information is stored in the above-mentioned data storage unit 36, and is used at the time of searching the route and at the time of calculating the aptitude of the driver for the route.

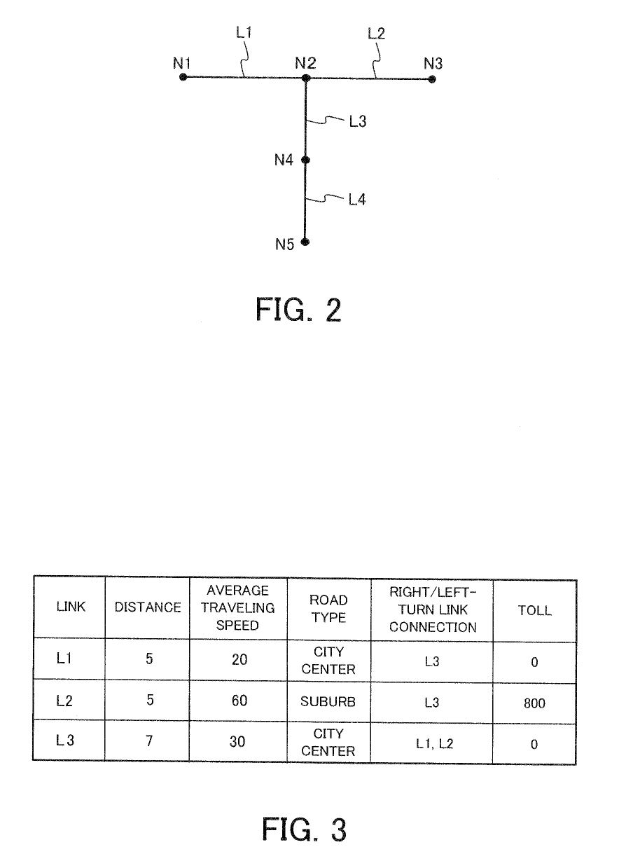

FIG. 2 is a diagram showing an example of nodes and links in the road map. The node shows a connection point of the links, and the link shows the road between the nodes. Five nodes N1 to N5 and four links L1 to L4 are shown in FIG. 2. Concretely, the link L1, the link L2 and the link L3 are connected by the node N2, and the link 3 and the link 4 are connected by the node N4.

FIG. 3 shows an example of the road information which the links L1 to L3 shown in FIG. 2 have. FIG. 3 shows the distance, the average traveling speed, the road type, the right/left-turn link connection showing the link connected by the right/left-turn, and the toll, as the road information. Concretely, there are the city center, the city highway and the suburb, as the road type.

### [Driving Characteristic Information]

Next, a description will be given of the driving characteristic information. The driving characteristic information is stored in the above-mentioned data storage unit 36, which is information showing an experience value and a characteristic about the driver. The driving characteristic information is used for calculating the characteristic of each driver for the route from the departure place to the destination.

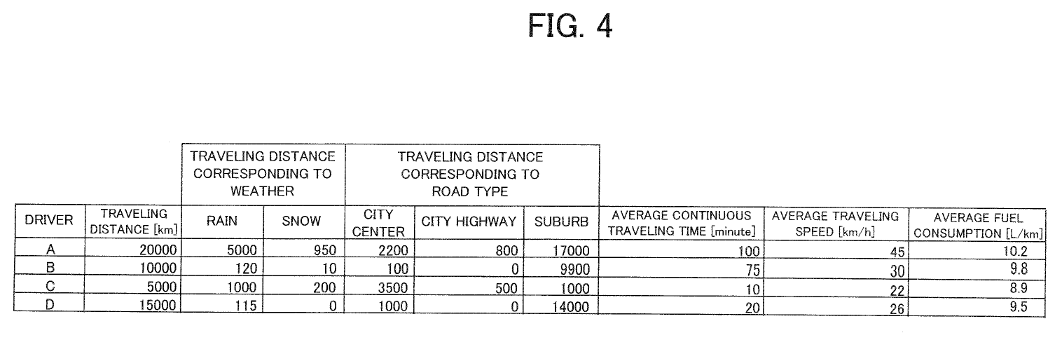

FIG. 4 is a diagram showing an example of the driving characteristic information for each of drivers A to D. In FIG. 4, there are shown the traveling distance corresponding to the weather, the traveling distance corresponding to the road type, the average traveling speed, the average continuous traveling time and the average fuel consumption, as the driving characteristic information. Concretely, the traveling distance corresponding to the weather indicates the traveling distance at the time of the rain and the snow. Namely, it can be thought that the traveling distance corresponding to the weather indicates the experience value of the driver corresponding to the weather. For example, it can be said that, as the traveling distance at the time of the snow becomes larger, the experience value of the driver corresponding to the snow also becomes higher. In addition, the traveling distance corresponding to the road type shows the traveling distance in the road of the city center, the city highway and the suburb. Namely, it can be thought that the traveling distance corresponding to the road type indicates the experience value of the driver corresponding to the road type.

As an example, the above driving characteristic information is obtained by a self report of each driver. Additionally, as another example, the driving characteristic information is produced by storing the past traveling data (traveling distance and traveling time) by the navigation apparatus 1. In this case, the CPU 22 certifies and personally distinguishes the drivers to store the traveling data. Thereby, the CPU 22 produces the driving characteristic information for each driver. Concretely, at the time of starting the driving, the CPU 22 obtains a password which the driver inputs by touching a touch panel, a finger print which is obtained when the driver touches the touch panel, and a voice print of the driver inputted via the sound input device. Then, the CPU 22 certifies the driver based on the information obtained in this manner, and stores the traveling data for each driver in a distinguishable manner.

Specifically, the traveling distance corresponding to the weather is produced in such a method that the CPU 22 relates the traveling distance to the weather obtained by the communication unit 38. In addition, the traveling distance corresponding to the road type is produced in such a method that the CPU 22 relates the traveling distance to the road type of the road information stored in the data storage unit 36. The average traveling speed and the average continuous traveling time are also produced by the stored traveling data. Concretely, the average traveling speed is calculated by dividing the traveling distance by the traveling time. Meanwhile, the average fuel consumption is produced by obtaining the correspondent information from the vehicle on which the navigation apparatus 1 is mounted.

### [Aptitude Calculation Method]

Next, a description will be given of a method of calculating the aptitude for the route up to the destination for each driver. The navigation apparatus 1 according to this embodiment calculates the aptitude for the searched route for each driver, based on the above-mentioned driving characteristic information. Thereby, in such a case that the plural people own the single vehicle, it becomes possible to appropriately determine the driver suitable for the route to the destination.

For example, the CPU 22 calculates the aptitude for the route to the destination for each driver, as an evaluation score. Concretely, the CPU 22 calculates the point for each component as shown by the following (A) to (D), and calculates the evaluation score based on the points.

### (A) Point Based on Road Type

Now, a description will be given of a method of calculating a point (hereinafter also referred to as “Cost C1”) for each driver based on the road type. In this case, since the road type forming the route is determined by the route search, the CPU 22 extracts, from the driving characteristic information, the traveling distance of each driver for the road type with reference to the data storage unit 36. Then, the CPU 22 calculates the Cost C1 for each driver based on the extracted traveling distance. Concretely, the CPU 22 sets the Cost C1 of the driver having the larger traveling distance of the road type forming the route to the higher value. Meanwhile, the CPU 22 sets the Cost C1 of the driver having the smaller traveling distance of the road type forming the route to the lower value.

### (B) Mark Based on Weather

Next, a description will be given of a method of calculating a point (hereinafter also referred to as “Cost C2”) for each driver based on the weather. In this case, the CPU 22 obtains the weather (corresponding to the weather forecast) in the calculated route from the communication device 38, and refers to the data storage unit 36 to extract, from the driving characteristic information, the traveling distance of each driver corresponding to the weather. Then, the CPU 22 calculates the cost C2 for each driver based on the extracted traveling distance. Concretely, the CPU 22 sets the Cost C2 of the driver having the larger traveling distance corresponding to the weather in the route to the higher value, and sets the Cost C2 of the driver having the smaller traveling distance to the lower value.

### (C) Point Based on Predicted Accident Rate

Next, a description will be given of a method of calculating a point (hereinafter also referred to as “Cost C3”) based on “predicted accident rate” showing a probability of an accident for each driver. The predicted accident rate is set based on the average traveling speed for each driver. It can be said that, as the predicted accident rate becomes higher, the safe driving ability of the driver is lower. Also, it can be said that, as the predicted accident rate becomes lower, the safe driving ability of the driver is higher.

The CPU 22 extracts the average traveling speed from the driving characteristic information, and calculates the predicted accident rate. Then, the CPU 22 calculates the Cost C3 for each driver. Concretely, the CPU 22 sets the Cost C3 of the driver having the low predicted accident rate to the high value, and sets the Cost C3 of the driver having the high predicted accident rate to the low value. In such a case that the navigation apparatus 1 includes a drive recorder, the predicted accident rate can be set based on the information (e.g., frequencies of sudden starting and sudden acceleration) collected and analyzed by the drive recorder.

### (D) Point Based on Average Continuous Traveling Time

Next, a description will be given of a method of calculating a point (hereinafter also referred to as “Cost 4”) for each driver, based on the average continuous traveling time. It can be said that, as the average continuous traveling time becomes longer, the continuous driving ability of the driver is higher. Also, it can be said that, as the average continuous traveling time becomes shorter, the continuous driving ability of the driver is lower.

In this case, the CPU 22 extracts the average continuous traveling time from the driving characteristic information, and calculates the Cost C4 for each driver. Concretely, the CPU 22 sets, to the comparatively high value, the Cost C4 of the driver (including the case of the same level) having the average continuous traveling time longer than the expected time of the route traveling, and sets, to the lower value, the Cost C4 of the driver having the average continuous traveling time extremely shorter than the expected time.

When the points (Costs C1 to C4) are calculated in the above methods, the CPU 22 calculates the aptitude of the driver for the route based on the Costs C1 to C4. Namely, the CPU 22 calculates the evaluation score corresponding to the route for each driver. As an example, the CPU 22 prescribes the value obtained by totalizing the Costs C1, C2, C3 and C4 as the evaluation score of the driver.

As another example, the CPU 22 weights and adds the Costs C1 to C4 to calculate the evaluation score of the driver. Concretely, the driver chooses at least any one of components, i.e., the road type, the weather, the predicted accident rate and the average continuous traveling time. Thereby, it becomes possible to enlarge the effect which the component has on the evaluation score of the driver. For example, when the driver chooses the component of the weather, the Cost C2 is multiplied by a coefficient (a value larger than 1). Thereby, the effect of the weather on the evaluation score becomes large.

### [Display Image Example]

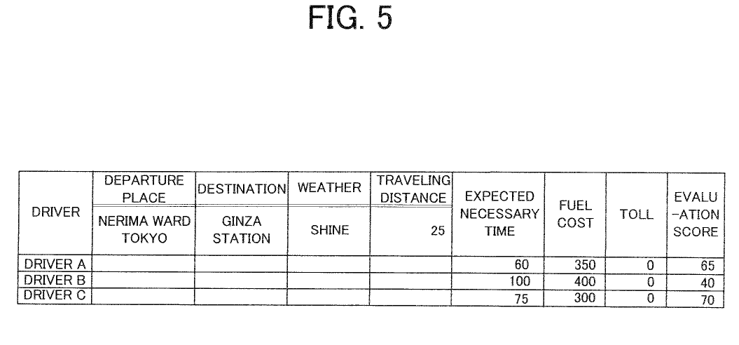

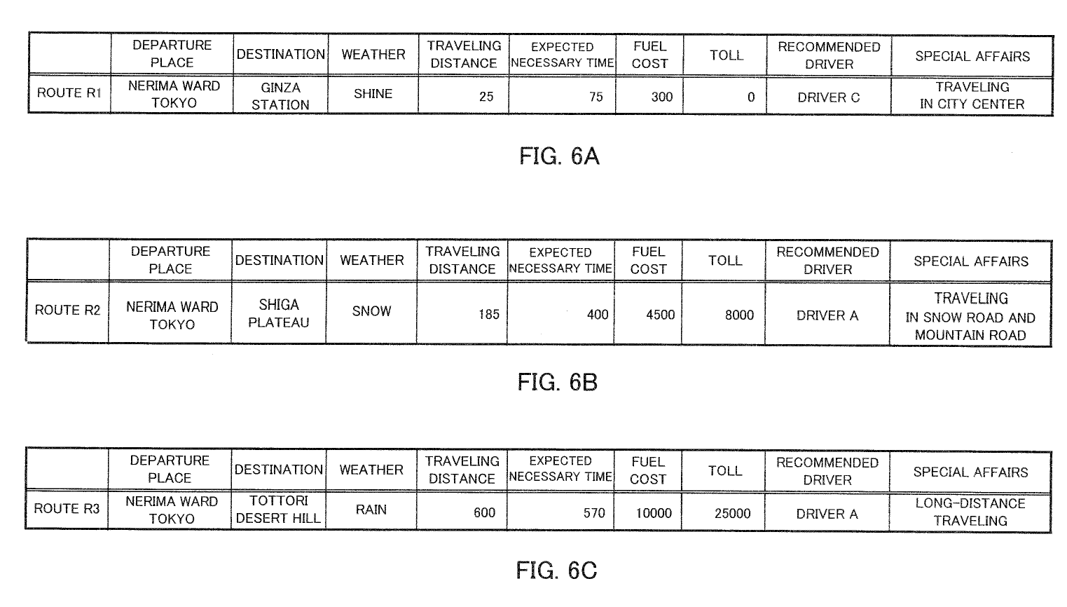

The aptitude (evaluation score) of the driver calculated in the above-mentioned manner is displayed on the display 44 by the CPU 22 and the display control unit 43. Now, a description will be given of an example of an image in which the aptitude of the driver is displayed. The images shown in FIG. 5 and FIGS. 6A to 6C are produced by using the information of the drivers A to D shown in FIG. 4.

FIG. 5 shows an image example of displaying the aptitude calculated for each of the drivers A to C as a list. Concretely, FIG. 5 shows not only the departure place, the destination, the weather and the traveling distance, which are used for calculating the aptitude, but also the expected necessary time, the fuel cost, the toll and the evaluation score for each driver. The expected necessary time is calculated based on the traveling distance and the speed obtained by reflecting the average traveling speed for each driver to the average traveling speed for each link. In addition, the fuel cost is calculated based on the traveling distance and the average fuel consumption for each driver. Meanwhile, the toll is primarily determined in correspondence with the searched route. Thus, there is usually no difference among any drivers. However, when the condition of the driver is different, e.g., with or without an ETC card and with or without a discount for a physically handicapped person, the toll may be different for each driver.

In an example shown in FIG. 5, the evaluation score of the driver C is the highest. Therefore, it can be said that the aptitude of the driver C for the calculated route is best. FIG. 5 shows such an example that the information is displayed in the order of the driver A, the driver B and the driver C. However, the information of the driver may be displayed in the order from the driver having the highest evaluation score. Namely, the information may be displayed in the order of the driver C, the driver A and the driver B.

FIGS. 6A to 6C show image examples of displaying only the information of the driver having the best aptitude for the calculated route (hereinafter referred to as “recommended driver”). The recommended driver is the driver having the highest evaluation score, and is determined by calculating the evaluation scores of all the drivers.

FIGS. 6A to 6C show not only the departure place, the destination, the weather and the traveling distance, which are used for calculating the aptitude, but also the expected necessary time, the fuel cost and the toll of the recommended driver. Namely, FIGS. 6A to 6C show the information of the recommended driver chosen at the time of setting the different routes (routes R1 to R3) and the different weathers (shine, snow and rain). The expected necessary time and the fuel cost are calculated by the method explained in FIG. 5. In addition, the information as to the road type, the weather and traveling is shown in special affairs.

In the example shown in FIG. 6A, the driver C is chosen as the recommended driver. In the example shown in FIG. 6B, the driver A is chosen as the recommended driver. In the example shown in FIG. 6C, the driver A is chosen as the recommended driver. In FIGS. 6A to 6C, it can be understood that the recommended driver is changed in correspondence with the weather.

### [Display Control Process]

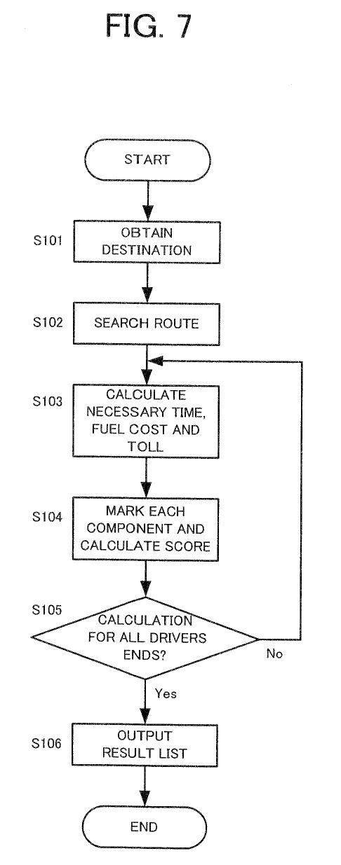

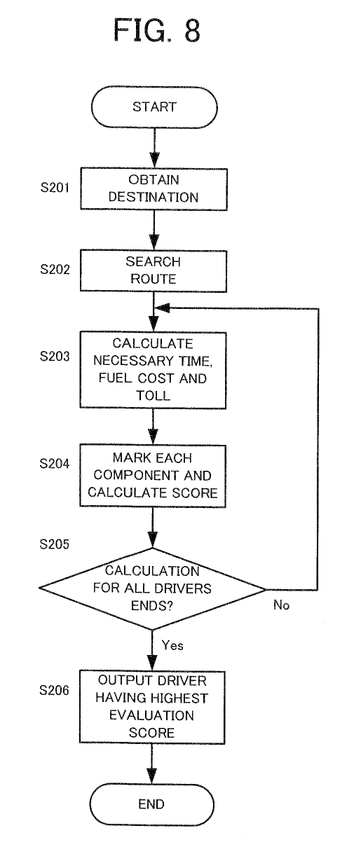

Next, a description will be given of a display control process according to this embodiment with reference to FIG. 7 and FIG. 8. The display control process is executed so that the image showing the aptitude of the driver for the route is displayed on the display 44.

FIG. 7 is a flow chart showing the process for displaying the aptitude calculated for each driver as the list. Namely, FIG. 7 shows the process executed at the time of producing the image shown in FIG. 5. The process is executed by the CPU 22.

First, the CPU 22 obtains the input corresponding to the destination from the driver in step S101. In this case, the CPU 22 obtains the signal corresponding to the operation of the input device 60 by the user. Then, the process goes to step S102.

The CPU 22 calculates the route from the departure place to the destination in step S102. Concretely, the CPU 22 searches the route by referring to the map data stored in the data storage unit 36. Then, the process goes to step S103.

In step S103, the CPU 22 calculates the expected necessary time, the fuel cost and the toll corresponding to the route calculated in step S102, for each driver. Concretely, the CPU 22 calculates the expected necessary time based on the traveling distance in the route and the speed obtained by reflecting the average traveling speed for each driver to the average traveling speed for each link. In addition, the CPU 22 calculates the fuel cost based on the traveling distance and the average fuel consumption for each driver. When the above process ends, the process goes to step S104.

In step S104, the CPU 22 calculates the evaluation score for each driver with using the driving characteristic information. For example, the CPU 22 calculates the points (Costs C1 to C4) for each component, i.e., the road type, the weather, the predicted accident rate and the average continuous traveling time, and calculates the evaluation score based on the calculated Costs C1 to C4. Then, the process goes to step S105.

In step S105, the CPU 22 determines whether or not the calculation for all the drivers ends. When the calculation for all the drivers ends (step S105; Yes), the process goes to step S106. Meanwhile, when the calculation for all the drivers does not end (step S105; No), the process returns to step S103, and the process is executed again.

In step S106, the CPU 22 displays the aptitude (evaluation score) calculated for each driver on the display 44, as the list. Concretely, the CPU 22 displays the expected necessary time, the fuel cost, the toll and the score, which are calculated for all the drivers, as the list (see FIG. 5). Then, the process goes out of the flow.

FIG. 8 is a flow chart showing a process for displaying the information of the driver having the best aptitude for the calculated route by priority. Namely, FIG. 8 shows the process executed at the time of producing the image shown in FIGS. 6A to 6C. In the process shown in FIG. 8, since the processes in steps S201 to S205 are similar to the processes in steps S101 to S105 explained in FIG. 7, an explanation thereof is omitted. Now, only the process in step S206 will be explained. This process is also executed by the CPU 22.

In step S206, the CPU 22 chooses the driver having the best evaluation score, based on the score obtained from all the drivers. Then, the CPU 22 determines the chosen driver as the recommended driver, and displays the image showing only the information of the recommended driver on the display 44. Concretely, the CPU 22 displays the image (see FIGS. 6A to 6C) showing the expected necessary time, the fuel cost, the toll and the special affairs of the recommended driver. Then, the process goes out of the flow.

As described above, the navigation apparatus according to this embodiment includes: the data storage unit which stores the road information; the CPU which calculates the route from the departure place to the destination based on the road information; the data storage unit which stores the driving characteristic information about driving for each of the plural users; the CPU which calculates the aptitude for the route, calculated by the route calculation unit, for each user, based on the driving characteristic information; and the CPU and the display control unit which displays the image corresponding to the aptitude calculated by the aptitude calculation unit. Thereby, in such a case that the plural users own the single vehicle in common, it becomes possible to appropriately determine the driver suitable for the route to the destination.

### [Modification]

In the above embodiment, the aptitude for the weather, the aptitude for the road type, the safe driving ability and the continuous driving ability are used as the driving characteristic information. However, the present invention is not limited to this. As another example, instead of or in addition to the components, a turning radius in a curve for each driver can be used as the driving characteristic information. In this case, when a difference between an actual curvature radius of the curve and the turning radius of the driver is large, the calculated point is made small. The turning radius in the curve is collected and analyzed by the drive recorder.

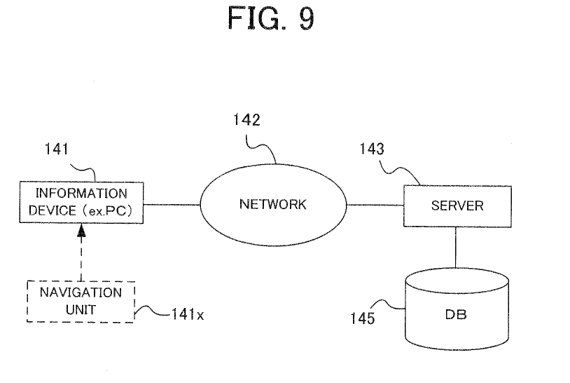

In the above embodiment, the information supplying apparatus of the present invention is applied to the on-vehicle navigation apparatus. Instead, the information supplying apparatus of the present invention can be also applied to an information device which is connected to a server via a network, such as a PC, a terminal device and a mobile phone. An example applied to the information device is shown in FIG. 9. In FIG. 9, the information supplying apparatus of the present invention is formed as an information device 141. The information device 141 is connected to a server 143 via a network 142 such as the Internet. The server 143 is connected to a DB 145. In this case, the road information about the road and the driving characteristic information about driving for each driver are stored in the DB 145. The driver can also calculate the aptitude for the searched route for each driver by using the information device 141 formed in this manner.

Recently, there is known an on-vehicle navigation apparatus including a main navigation unit attachable to and detachable from the vehicle. The navigation unit of this kind is detached from the vehicle, and is connected to the PC at home to be used. In this case, as shown by a broken line in FIG. 9, a navigation unit 141x is connected to the information device 141 and is connected to the server 143 via the network 142 to receive the information from the DB 145. Thereby, the aptitude for the route can be calculated for each driver. In this case, the aptitude for the route is calculated for each driver by activating the program stored in the navigation unit 141x with using the information device 141.

In addition, in the above embodiment, the obtained result is displayed on the image display unit. In addition, the aptitude of the driver may be outputted by the sound.

### INDUSTRIAL APPLICABILITY

This invention can be used for an on-vehicle navigation apparatus.

1-11. (canceled)

12. An information supplying apparatus comprising:
a road information storage unit which stores road information;
a route calculation unit which calculates a route from a departure place to a destination based on the road information;
a driving characteristic information storage unit which stores driving characteristic information about driving for each of plural users;
an aptitude calculation unit which calculates an aptitude for the route calculated by the route calculation unit for each user, based on the driving characteristic information; and
a display control unit which displays an image corresponding to the aptitude calculated by the aptitude calculation unit.

13. The information supplying apparatus according to claim 12, wherein the display control unit displays the aptitude calculated for each user as a list.

14. The information supplying apparatus according to claim 12, wherein the display control unit displays information of a user having a best aptitude by priority, based on the aptitude calculated for each user.

15. The information supplying apparatus according to claim 12, further comprising a weather forecast information obtaining unit which obtains weather forecast information corresponding to the route,
wherein the driving characteristic information storage unit stores an aptitude for a weather for each user as the driving characteristic information, and
wherein the aptitude calculation unit calculates an aptitude for the route based on the weather forecast information and the aptitude for the weather.

16. The information supplying apparatus according to claim 12,
wherein the driving characteristic information storage unit stores an aptitude for a road type for each user as the driving characteristic information, and
wherein the aptitude calculation unit calculates the aptitude for the route based on the aptitude for the road type.

17. The information supplying apparatus according to claim 12,
wherein the driving characteristic information storage unit stores safe driving ability for each user as the driving characteristic information, and
wherein the aptitude calculation unit calculates the aptitude for the route based on the safe driving ability.

18. The information supplying apparatus according to claim 12,
wherein the driving characteristic information storage unit stores a continuous driving ability showing ability capable of continuously driving for each user as the driving characteristic information, and
wherein the aptitude calculation unit calculates the aptitude for the route based on the continuous driving ability.

19. The information supplying apparatus according to claim 12,
wherein the driving characteristic information is formed by plural parameters, and
wherein the aptitude calculation unit includes a unit which designates a priority of the parameter used at a time of calculating the aptitude, and calculates the aptitude by using the parameter based on the designated priority.

20. The information supplying apparatus according to claim 12, further comprising: a driving information collection unit which collects information about driving of the user during driving,
wherein the driving characteristic information is updated based on collected driving information.

21. An information supplying method which produces information to be displayed on an image display unit, comprising:
a road information obtaining process which obtains road information;
a route calculation process which calculates a route from a departure place to a destination based on the road information;
a driving characteristic information obtaining process which obtains driving characteristic information about driving for each of plural users;
an aptitude calculation process which calculates an aptitude for the route calculated in the route calculation process for each user, based on the driving characteristic information; and
a display control process which displays an image corresponding to the aptitude calculated in the aptitude calculation process.

22. A computer program product in a computer-readable medium executed by an information supplying apparatus comprising a computer for producing information to be displayed on an image display unit, the information supplying apparatus making the computer function as:
a road information obtaining unit which obtains road information;
a route calculation unit which calculates a route from a departure place to a destination based on the road information;
a driving characteristic information obtaining unit which obtains driving characteristic information about driving for each of plural users;
an aptitude calculation unit which calculates an aptitude for the route calculated by the route calculation unit for each user based on the driving characteristic information; and
a display control unit which displays an image corresponding to the aptitude calculated by the aptitude calculation unit.
